(19) United States
(12) Patent Application Publication
(10) Pub. No.: US 2009/0311009 A1
(43) Pub. Date: Dec. 17, 2009

(54) DEVELOPING DEVICE AND IMAGE FORMING APPARATUS HAVING THE DEVELOPING DEVICE

(75) Inventors: Shigeki NAIKI, Toyokawa-shi (JP); Hironori Akashi, Okazaki-shi (JP); Soh Hirota, Hoi-gun (JP); Mitsuru Obara, Toyohashi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/400,977

(22) Filed: Mar. 10, 2009

(30) Foreign Application Priority Data
Jun. 16, 2008 (JP) 2008-156322

(51) Int. Cl. G03G 15/08

(52) U.S. Cl. 399/254

(57) ABSTRACT

In a developer cartridge of toner and carrier, uneven distribution of the carrier at least in the vicinity of a replenishing port is eliminated regardless of the composition ratio between the carrier and the toner and the specific gravity of the carrier. Provided is a construction including a developer container in which a developer containing toner and carrier is received and which has a developing roller to supply the toner to an image carrier, a developer cartridge in which a replenishing developer containing the toner and the carrier is received and which has a replenishing port connected to the developer container to allow the developer container to be replenished with the developer via the replenishing port, and stirring means capable of stirring the developer located at least in the vicinity of the replenishing port in the developer cartridge.

### RELATED APPLICATION

The present invention is based on Patent Application No. 2008-156322 filed in Japan.

### BACKGROUND OF THE INVENTION

The present invention relates to a developing device and an image forming apparatus having the developing device.

Generally, in a so-called trickle system image forming apparatus in which a developer containing toner and carrier is supplied and discharged, the developer is appropriately supplied from a replenishing port of a developer cartridge into a developer container of the developing device.

The carrier has a large specific gravity in comparison with that of the toner and tends to be unevenly distributed perpendicularly on the lower side by receiving the influence of gravity. If the carrier is unevenly distributed in the vicinity of the replenishing port of the developer cartridge, then the replenishing port is clogged, and the replenishment failure of the developer into the developer container occurs.

Therefore, a developing device in which the developer conveyance capacity is improved by projectingly providing a helical projecting thread inwardly from the inner wall that constitutes the replenishing port in order to prevent the replenishing port from being clogged with the developer is proposed (refer to, for example, Patent Document 1).

Patent Document 1: JP 2004-29306 A

However, in the conventional developer described above, not only the shape of the inner wall that constitutes the replenishing port but also the construction of the developer to be used are restricted. That is, the developer needs to contain carrier and toner at a composition ratio of 1 to 30 parts of the toner with respect to one part of the carrier by weight ratio and to have a true specific gravity of 2.5 to 4.5 of the carrier. Accordingly, a developer that does not satisfy the conditions has a problem that the carrier segregates in the lower part and on the inner wall of the developer cartridge and the developer container cannot smoothly be internally replenished with the developer.

### SUMMARY OF THE INVENTION

An object of the present invention is to provide a developing device capable of reliably supplying a developer from a developer cartridge into a developer container while eliminating clogging in the replenishing port with the developer and an image forming apparatus that has the developing device.

As a means for solving the above problems, the invention provides

a developing device including:

a developer container in which a developer containing toner and carrier is received and which has a developing roller to supply the toner to an image carrier;

a developer cartridge in which a replenishing developer containing toner and carrier is received and which has a replenishing port connected to the developer container to allow the developer container to be replenished with the developer via the replenishing port; and

stirring means capable of stirring the developer located at least in the vicinity of the replenishing port in the developer cartridge.

With the construction, the developer at least in the vicinity of the replenishing port in the developer cartridge can be stirred by the stirring means. Therefore, it is possible to reliably replenish the developer container with the developer by eliminating the clogging due to the uneven distribution of the carrier in the vicinity of the replenishing port. Moreover, stable replenishment can be achieved by uniforming the toner concentration before the replenishment of the developer container by stirring the developer in the developer cartridge.

It is preferable to further provide stirring control means for stirring the developer by controlling driving of the stirring means before the developer container is replenished with the developer via the replenishing port.

With the construction, the developer at least in the vicinity of the replenishing port can surely be stirred by the stirring means when the developer container is replenished with the developer, and therefore, the replenishing port is not clogged with the developer.

It is preferable that timing means capable of timing a rest time of the stirring means is further provided, and

the stirring control means makes the stirring means drive to stir the developer when the rest time timed by the timing means elapses beyond a preset time.

With the construction, it is possible to prevent the carrier from being gradually unevenly distributed on the lower side under the influence of gravity and from causing clogging in advance even if frequency of use is low.

It is preferable that vibration amount detecting means for detecting a vibration amount of the developer cartridge is further provided, and

the stirring control means makes the stirring means drive to stir the developer when a detection vibration amount detected by the vibration amount detecting means exceeds a preset reference vibration amount.

With the construction, the developer can be stirred when the developer receives the influence of the vibration and the carrier tends to be unevenly distributed on the lower side, and therefore, the developer can be restored into a satisfactory state with excellent flowability.

It is preferable that environment detecting means for detecting an environmental condition in the developer container is further provided, and

the stirring control means controls driving of the stirring means on the basis of a difference in the environmental condition detected by the environment detecting means.

The environment detecting means is only required to be at least either one of a humidity sensor for detecting humidity in the developer container and a temperature sensor for detecting temperature in the developer container.

With the construction, when it is anticipated that the environmental condition of the developer deteriorates and the replenishing port tends to be clogged with the developer, it is possible to secure the desired flowability by stirring the developer in advance and to reliably replenish the developer container with the developer.

It is preferable that the stirring means is a stirring blade which is placed on the developer container side and located at least in the vicinity of the replenishing port in the developer cartridge when the developer cartridge is mounted to the developer container.

With the construction, it is possible to simplify the construction of the developer cartridge replaced frequently, allowing the developer to be inexpensively manufactured.

It is preferable that the stirring means has a stirring blade placed in the developer cartridge and a rotary driving part placed on the developer container side, and

the stirring blade is connected drivably by the rotary driving part when the developer cartridge is mounted to the developer container.

With the construction, the developer cartridge needs no structure for inserting the stirring blade, and therefore, a state in which the developer is received can be made excellent in hermeticity.

The stirring blade may be of a rotary type.

It is acceptable that the developer container and the developer cartridge are placed upright and the developer container can be replenished with the developer from the developer cartridge via the replenishing port on the lower side, and

the stirring means is constructed of a conveyance screw for circulating the developer located on the lower side in the developer cartridge by upwardly conveying the developer.

Moreover, as a means for solving the above problems, the invention provides an image forming apparatus having any one of the developing devices described above.

According to the invention, the developer at least in the vicinity of the replenishing port of the developer cartridge is stirred, and therefore, the trouble that the carrier is unevenly distributed in the vicinity of the replenishing port causing the clogging and the replenishment failure of the developer can be eliminated. Moreover, the carrier in the developer cartridge can be uniformed as a secondary effect of stirring, and therefore, the toner concentration of the developer replenished to the developer container can be stabilized.

### BRIEF DESCRIPTION OF THE DRAWINGS

FIG. 1 is a schematic view showing the overall construction of an image forming apparatus according to the present embodiment;

FIG. 2 is a schematic view showing the construction of the developing device of FIG. 1;

FIG. 3 is a schematic view showing the construction of the developer container of FIG. 2;

FIG. 4 is a schematic view showing the construction of the developer container and the developer cartridge of FIG. 2;

FIG. 5A and FIG. 5B are a schematic view and a side view, respectively, showing the construction of the developer cartridge of FIG. 4;

FIG. 6 is a block diagram of the image forming apparatus of the present embodiment;

FIG. 7 is a flow chart showing a developer replenishing process executed by the control unit of FIG. 6;

FIG. 8 is a schematic view showing the construction of a developer container and a developer cartridge according to another embodiment;

FIG. 9A and FIG. 9B are a schematic view and a side view, respectively, showing the construction of the developer cartridge of FIG. 8; and

FIG. 10 is a schematic view showing the construction of a developer container and a developer cartridge according to another embodiment.

### DETAILED DESCRIPTION OF THE INVENTION

Embodiments of the invention will be described below with reference to the accompanying drawings. In the following description, the types, combinations, shapes, relative configurations and so on of the constituent elements are not limited only to the technical scope of the invention unless specifically described. Moreover, although the terms (e.g., terms including “upper”, “lower”, “one end”, “the other end” etc.), which appropriately indicate specific directions and positions as occasion demands, are used, those terms are used to facilitate the understanding of the invention with reference to the drawings, and the technical scope of the invention is also not limited by the meanings of those terms.

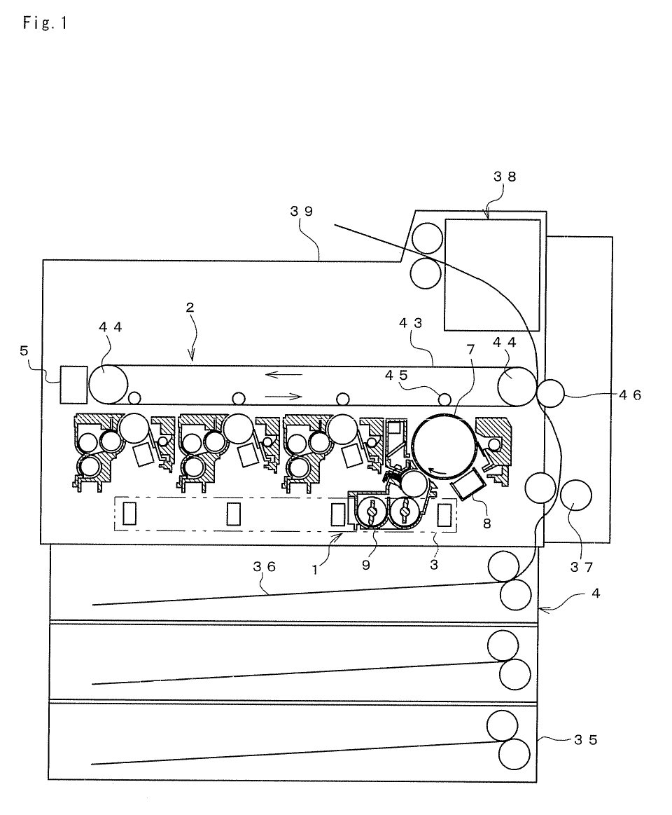

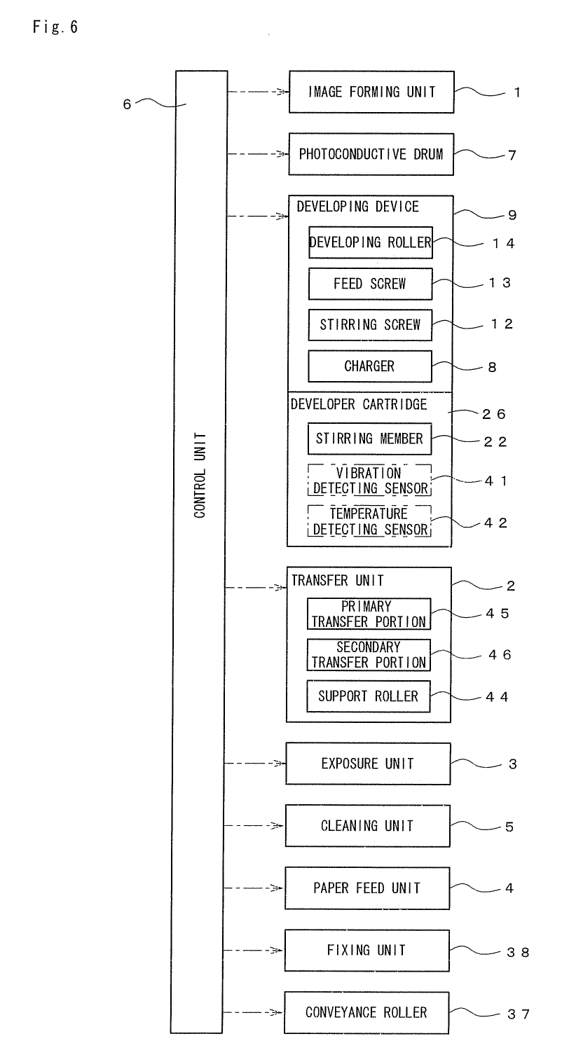

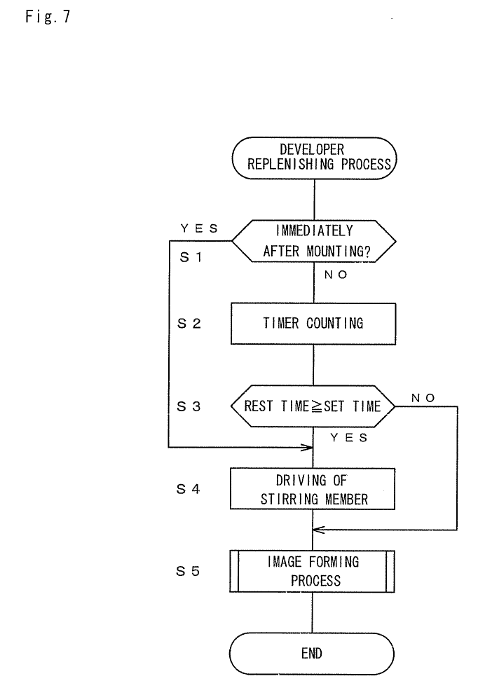

FIG. 1 shows, in particular, a so-called trickle system image forming apparatus, which is replenished with not only a toner but also a developer, among electrophotographic systems that use a two-component developer. The image forming apparatus generally includes an image forming unit 1, a transfer unit 2, an exposure unit 3, a paper feed unit 4, a cleaning unit 5, a control unit 6 (see FIG. 6) and so on.

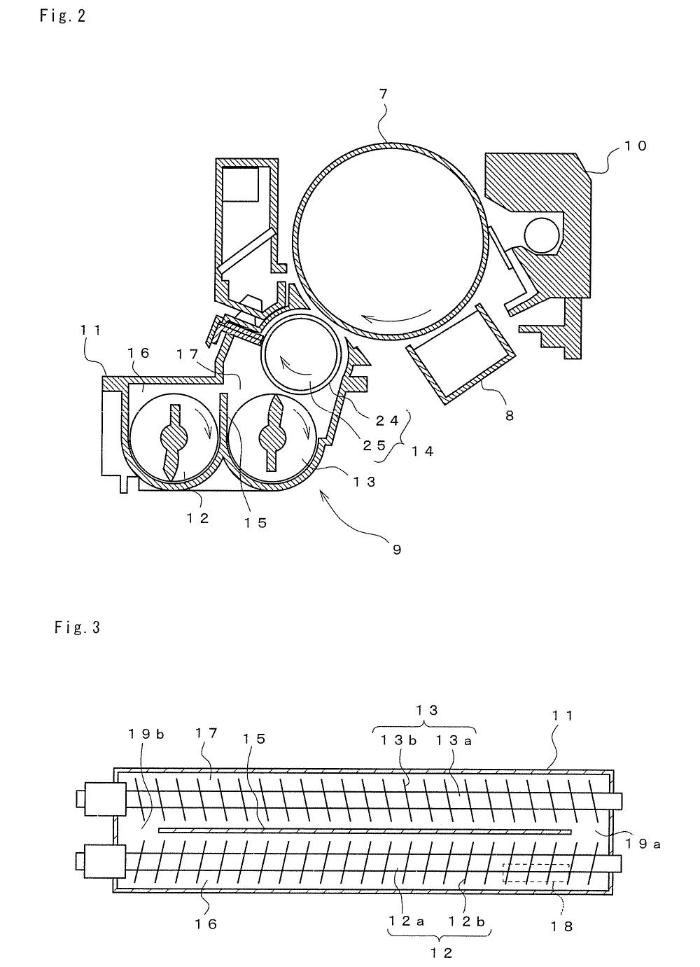

The image forming unit 1 is placed in four places along an intermediate transfer belt 43 of the transfer unit 2 and forms a color image on the surface of the intermediate transfer belt 43 by performing image formation of yellow (Y), magenta (M), cyan (C) and black (Bk) from the left-hand side. As shown in FIG. 2, a charger 8, a developing device 9, a cleaning device 10 and so on are provided around a photoconductive drum 7.

The photoconductive drum 7 is constituted by forming an organic photoconductor layer (OPC) on the surface of which an overcoat layer (protecting layer) is provided on the outer periphery of a cylindrical metal base body formed of, for example, an aluminum material. The photoconductive drum 7 is rotationally driven in a grounded state upon receiving a driving force from the intermediate transfer belt 43 by the movement of the intermediate transfer belt 43 in a contact state as described later.

The charger 8 produces a charging effect (negative charging in the present embodiment) by a control grid and a corona discharge electrode kept at respective prescribed voltages with corona discharge of the same polarity (negative polarity in the present embodiment) as that of the toner (toner for developing) used to give a uniformly distributed voltage to the photoconductive drum 7. It is also possible to otherwise use a sawtooth electrode or a needle electrode as the corona discharge electrode of the charger 8.

The developing device 9 receives a stirring screw 12, a feed screw 13 and a developing roller 14 that is a developer carrier in the developer container 11.

As shown in FIG. 3, the developer container 11 has a generally box-like elongate shape extended from one end side to the other end side and is internally divided into two parts of a first compartment 16 and a second compartment 17 extended along the lengthwise direction by a partition wall 15. A replenishing inlet 18 is formed on the one end side of the first compartment 16 and connected to a replenishing port 32 of a developer cartridge 26, which is described later, to be replenished with a developer. Moreover, a deteriorated developer is appropriately discharged via a discharge outlet (not shown) provided at the other end of the second compartment 17. Both end sides of the first compartment 16 and the second compartment 17 communicate with each other via communicating portions 19a, 19b, and the received developer circulatingly move while being stirred.

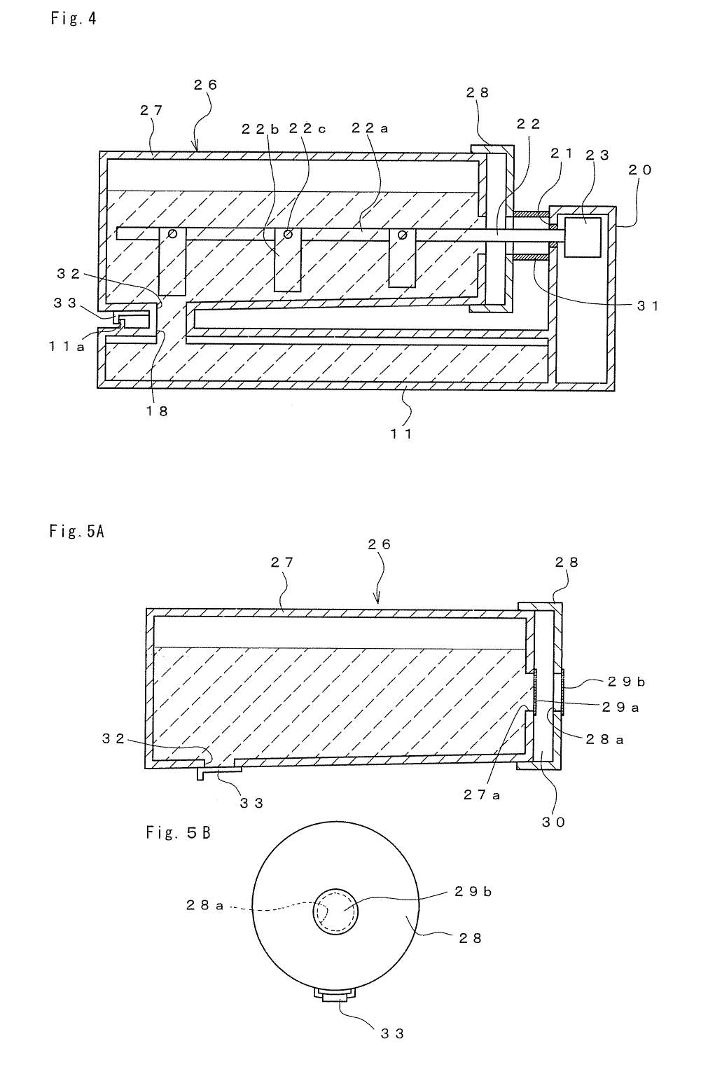

As shown in FIG. 4, a supporting wall portion 20 is upwardly extended and integrated with the one end side of the developer container 11. At the supporting wall portion 20, a stirring member 22 that is stirring means is rotatably supported to a bearing portion 21 on the upper side. The stirring member 22 is formed by integrating a rotary shaft 22a with a plurality of (three in this case) stirring blades 22b provided at prescribed intervals in the axial direction thereof. A driving force 23 such as a motor received in the supporting wall portion 20 is connected to the one end portion of the rotary shaft. The stirring member 22 is pivotally attached to the rotary shaft 22a around a spindle 22c.

As shown in FIG. 3, the stirring screw 12 has a construction in which a helical blade 12b is provided around the rotary shaft 12a and is placed in the first compartment 16. The stirring screw 12 stirs the developer while conveying the developer from the one end side (communicating portion 19a side) to the other end side (communicating portion 19b side) by being rotationally driven.

Like the stirring screw 12 described above, the feed screw 13 has a construction in which a helical blade 13b is provided around a rotary shaft 13a and is placed in the second compartment 17. The feed screw 13 conveys the developer from the communicating portion 19b side to the communicating portion 19a side and feeds the developer to the developing roller 14 by being rotationally driven.

In the developing roller 14, as shown in FIG. 2, a plurality of permanent magnets 25 are received in a cylindrical sleeve 24 (in this case, five permanent magnets S2, N2, S1, N1, S3 are arranged in this order in the clockwise direction). The sleeve 24 is constructed so as to forwardly and reversely rotate in the circumferential direction by sleeve driving means (not shown).

As shown in FIGS. 4 and 5, the developer cartridge 26 that supplies a replenishment two-component developer (hereinafter referred to as a developer) constituted of toner and carrier is made detachable above the developing device 9.

In the developer cartridge 26, as shown in FIG. 5, an opening 27a into which the stirring member 22 is inserted is provided at the one end portion of a cylindrical cartridge main body 27 and is covered with a cap 28. The opening 27a of the cartridge main body 27 and a center hole 28a of the cap 28 are covered with films 29a and 29b, respectively. These films 29a, 29b are pierced by the stirring member 22 when the developer cartridge 26 is mounted to the developer container 11.

The cap 28 is made of an elastically deformable material such as a rubber or polyethylene and mounted in a closely fit state so that a prescribed gap is formed between the cap 28 and an end surface of the cartridge main body 27. The gap functions as a reservoir portion 30 to reserve the developer flowing from the inside when the film 29a of the opening 27a is pierced by the stirring member 22, preventing the developer from falling to the outside. Moreover, cylindrical packing 31 provided on the developer container side is press fit to the periphery of the center hole 28a of the cap 28. With this arrangement, even if the developer flows from the reservoir portion 30 to the outside by any chance, the developer can be reserved in a space surrounded by the packing 31. It is also possible to eliminate the cap 28 and to prevent the developer from flowing out only by the packing 31.

The replenishing port 32 is formed on the lower surface on the other end side of the cartridge main body 27. The replenishing port 32 is closed by a shutter 33. When the developer cartridge 26 is mounted to the developer container 11, the shutter 33 opens to be connected to the replenishing inlet 18 of the developer container 11, allowing the developer container 11 to be internally replenished with the developer. Moreover, the bottom surface of the cartridge main body 27 is formed to gradually incline perpendicularly downwardly toward the replenishing port 32. With this arrangement, the developer received in the cartridge main body 27 smoothly flows to the replenishing port 32 and is discharged into the developer container 11.

In mounting the developer cartridge 26 to the developer container 11, the stirring member 22 is inserted into the center hole 28a of the cap 28 and then into the opening 27a of the cartridge main body 27. At this time, the stirring blades 22b pivot along the rotary shaft 22a around the spindles 22c, and therefore, the inserting operation is not disturbed if the center hole 28a and the opening 27a are made small. Moreover, in mounting the developer cartridge 26 to the developer container 11, the shutter 33 of the developer cartridge 26 is automatically opened by a projection 11a formed on the developer container 11, and the replenishing port 32 communicates with the replenishing inlet 18.

The thus-mounted state is detected by detecting means of a limit sensor, an optical sensor or the like (not shown). When the stirring member 22 is rotationally driven, the stirring blades 22b inserted in the cartridge main body 27 receive a centrifugal force and pivot from a folded position along the rotary shaft 22a to a projecting stirring position almost perpendicular to the rotary shaft 22a. This operation makes it possible to stir the developer received in the cartridge main body 27. Moreover, the stirring blade attached to the leading end portion of the rotary shaft 22a among the stirring blades 22b located in the cartridge main body 27 is positioned so as to be pivotable in the vicinity of the replenishing port 32. Therefore, the carrier unevenly distributed in the vicinity of the replenishing port 32 can be dispersed, and replenishment failure due to the clogging of the developer 22 in the replenishing port 32 can be prevented.

The stirring blades 22b, which have a flat plate-like shape with rigidity, may be constructed of a leaf spring, a coil spring, a brush or the like, and the shape and the material thereof can freely be selected so long as it can stir the developer. In particular, with the elastic construction of the leaf spring, coil spring, brush or the like, the developer is not deteriorated by a forced stress effected on the developer, and it is also possible to prevent the damage of the stirring blades 22b themselves.

Moreover, it is acceptable to provide the elastic member of the leaf spring, rubber or the like for the spindle 22c, so that the stirring blades 22b automatically return to the stirring positions. This makes it possible to reliably stir the developer in the vicinity of the replenishing port 32 by the stirring blades 22b regardless of the rotating speed of the stirring member 22.

Moreover, it is acceptable to provide a conveyance coil or a conveyance screw in the developer cartridge 26 and to compulsorily convey the developer to the replenishing port 32. This obviates the need for inclining the bottom surface of the developer cartridge 26.

As shown in FIG. 2, after transfer onto the surface of the photoconductive drum 7, the cleaning device 10 cleans the toner remaining on the surface.

As shown in FIG. 1, the transfer unit 2 is constructed so that the intermediate transfer belt 43 is looped around one pair of support rollers 44 and the support rollers 44 are driven by driving means (not shown) to circulatingly move the intermediate transfer belt 43 in the arrow direction and includes a primary transfer portion 45 and a secondary transfer portion 46.

Each of the primary transfer portion 45 is provided facing the photoconductive drum 7 of each color with interposition of the intermediate transfer belt 43, respectively. Each of the primary transfer portion 45 forms a transfer region (not denoted) of each color between the intermediate transfer belt 43 and the photoconductive drum 7 of each color. A dc voltage of a polarity (positive polarity in the present embodiment) opposite to the polarity of the toner is applied to the primary transfer portion 45 of each color to form a transfer electric field in the transfer region and transfer a toner image on the photoconductive drum 7 of each color onto the intermediate transfer belt 43. The primary transfer portion 45 should preferably be constructed of a corona discharge device.

In the exposure unit 3, an exposure position is placed on the photoconductive drum 7 so as to be positioned on the downstream side in the rotational direction of the photoconductive drum 7 with respect to the charger 8 of each color described above. Then, the exposure unit 3 exposes an image on the photoconductor layer of the photoconductive drum 7 according to the image data of each color that have been read by a separate image reading device to form an electrostatic latent image on the photoconductive drum 7 of each color.

The paper feed unit 4 successively conveys recording media 36 received in a cassette 35 to the secondary transfer portion 46 via a conveyance roller 37. A toner image is transferred onto the recording medium 36 conveyed to the secondary transfer portion 46, and the toner image transferred by a fixing unit 38 is fixed and thereafter ejected to a copy receiving tray 39.

The cleaning unit 5 can move so as to come in contact with and apart from the intermediate transfer belt 43 and is able to collect the toner remaining on the intermediate transfer belt 43.

The control unit 6 executes an image forming process and so on as in the conventional case and executes a developer replenishing process.

Operation of the image forming apparatus constructed as above is described next. It is noted that the following description refers only to the replenishing process of the developer into the developer container 11 that is the characteristic part of the invention.

First of all, as shown in FIG. 7, it is judged whether or not a new developer cartridge 26 is mounted to the developer container 11 (step S1). If it has already been mounted, the driving state of the stirring member 22 is detected, and an elapsed time from the stop of the rotation of the stirring member 22 is counted by a timer (built in the control unit 6) (step S2). Then, it is judged whether or not the counted time, i.e., a rest time has elapsed over a preset time (set time) (step S3).

When it is judged in step S1 that the developer cartridge 26 is immediately after being mounted, the stirring member 22 is rotationally driven by the driving force 23, and, in particular, the developer located in the vicinity of the replenishing port 32 is stirred by the stirring blade 22a (step S4). By this operation, if a time has elapsed from when the developer is received in the developer cartridge 26 and a carrier of a great specific gravity is unevenly distributed in the vicinity of the replenishing port 32, the developer is stirred to allow the flowability of the developer to be recovered. That is, it is possible to smoothly flow the developer from the developer cartridge 26 into the developer container 11 via the replenishing port 32. Moreover, since the stirring blades 22a are provided not only in the vicinity of the replenishing port 32 but also in other portions, the developer in the developer cartridge 26 is stirred throughout. Therefore, the toner concentration in the developer cartridge 26 can be uniformed, and it is possible to stabilize the toner concentration of the developer replenished into the developer container 11 to a desired value.

Moreover, when it is judged that the rest time has elapsed over the set time in step S3, it is highly possible that the developer is solidified or the amount of charging of the toner is changed (decreased). Accordingly, the stirring member 22 is rotationally driven by the driving force 23 as in the above case, and, in particular, the developer located in the vicinity of the replenishing port is stirred by the stirring blades 22b (step S4). By this operation, even if a time has elapsed from when the developer is received in the developer cartridge 26 and the carrier of a great specific gravity is unevenly distributed in the vicinity of the replenishing port 32, the developer is stirred to allow the flowability of the developer to be recovered.

Subsequently, if the stirring of the developer by the stirring member 22 ends, the program flow proceeds to the image forming process as in the conventional case (step S5).

As described above, when a new developer cartridge 26 is mounted and when the rest time of the stirring member 22 exceeds the set time, the stirring member 22 is automatically rotationally driven to stir the received developer. That is, by limiting the rotational driving of the stirring member 22 to a necessary minimum range, the carrier can be prevented from deteriorating upon receiving a stress in comparison with the case of continuous stirring.

It is noted that the invention is not limited to the construction described in the above embodiment but allowed to be variously modified.

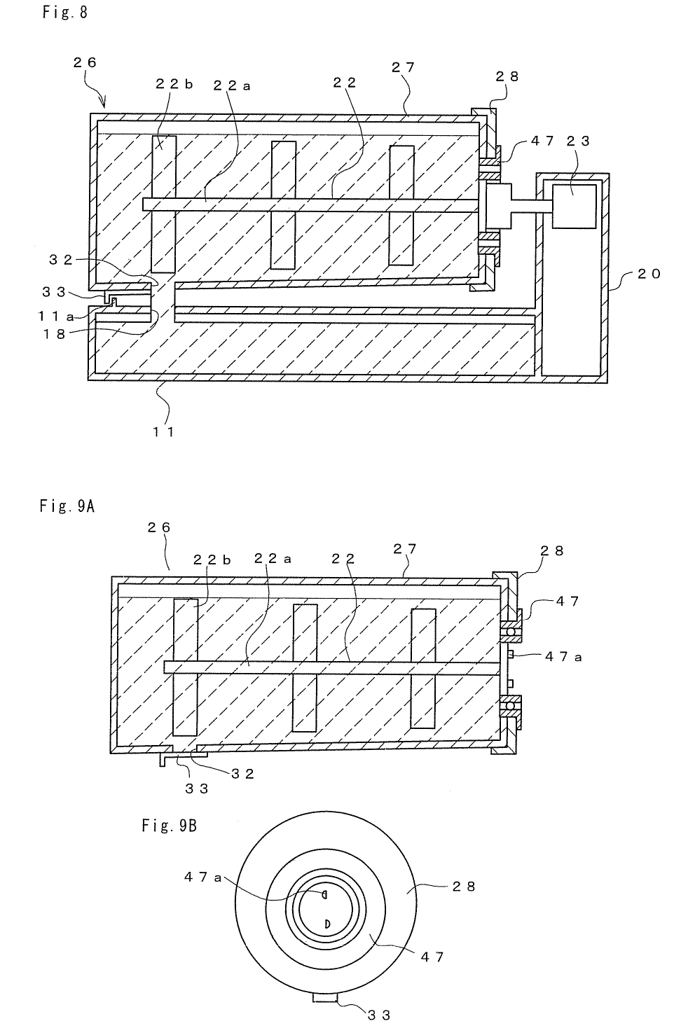

As shown in FIGS. 8 and 9, the stirring member 22 may be integrated with the inside of the developer cartridge 26. That is, one end portion of the rotary shaft 22a is rotatably supported by a bearing portion 47 in a state in which the stirring blades 22b are placed in the developer cartridge 26. In this case, it is proper to use a ball bearing having an excellent sealing property at the bearing portion 47. However, the bearing portion may be constructed of another bearing having a similar function. Then, a portion exposed to the outside of the bearing portion 47 and a leading end portion of the rotary shaft of the driving force 23 projecting from the supporting wall portion 20 are connected together allowing a force to be transmitted by, for example, a plurality of projections 47a and a plurality of recess portions (a gear or the like is acceptable) with which the projections 47a are engaged. This makes it possible to reliably prevent the developer from flowing out at the time of mounting or dismounting the developer cartridge 26 without needing the reservoir portion 30.

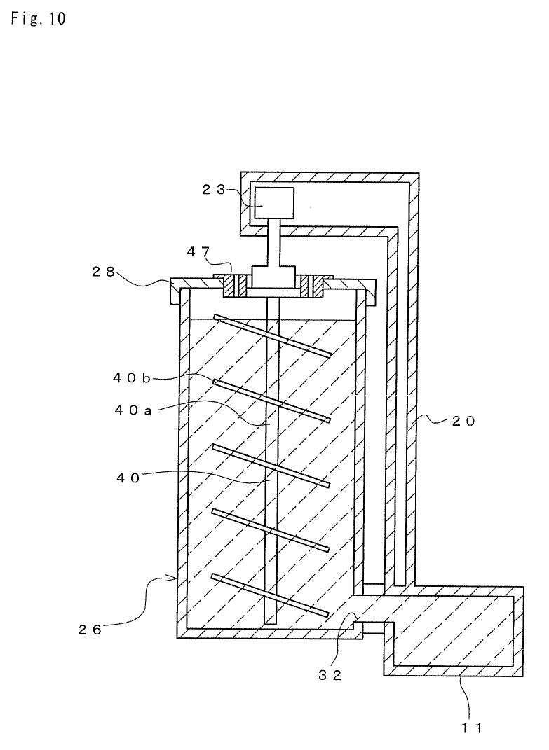

As shown in FIG. 10, the developer cartridge 26 may be placed upright. In the developer cartridge 26, the replenishing port 32 is formed at a side surface in a lower end portion, and a conveyance screw 40 rotatably supported to the bearing portion 47 of the upper end surface is received. With regard to the conveyance screw 40, a helical blade portion 40b is formed around a rotary shaft 40a. By transmitting a force from the driving force 23 such as a motor, it is possible to convey the developer while stirring the developer from the lower side to the upper side on the inner peripheral surface side and to circulatingly move the developer downward on the outer peripheral surface side. With this arrangement, when the conveyance screw 40 is rotationally driven under conditions such that the carrier is unevenly distributed on the lower side, the carrier unevenly distributed in the vicinity of the replenishing port 32 can be dispersed, and supply failure due to the clogging of the developer in the replenishing port 32 can be prevented. It is noted that the conveyance screw 40 is not limited to one in number but allowed to be provided in plurality.

It is acceptable to provide a vibration detecting sensor 41 (see FIG. 6) to detect vibration at the developer cartridge 26 and to determine whether or not to drive the stirring member 22 on the basis of the detected amount of vibration (detected vibration amount). That is, if the detected vibration amount exceeds a preset reference vibration amount, it is determined that the carrier in the developer possibly suffers the influence of vibration and moves to the lower side causing a concern about the uneven distribution, and the stirring member 22 is rotationally driven. This makes it possible to recover the flowability by stirring the developer in advance before the replenishing port 32 is clogged with the developer. Moreover, the developer can be stirred also in other regions, and therefore, it becomes possible to maintain the toner concentration uniform as a whole in the developer cartridge 26 as described above and to supply the toner in a stable state into the developer container 11.

Moreover, it is acceptable to provide a temperature detecting sensor 42 (see FIG. 6) and to determine whether or not to drive the stirring member 22 on the basis of a difference in the detected temperature. Although the temperature detecting sensor should preferably be able to detect the temperature in the developer cartridge 26, it is acceptable to place the sensor in a position where the environmental temperature can be detected. Then, it is proper to estimate the state of the developer on the basis of the difference in the detected temperature and to judge whether or not a condition in which the developer is easily solidified or a condition in which the amount of charging of the toner is easily lowered is satisfied. If the detected temperature is lower than a preset reference temperature, the amount of charging of the toner is recovered by rotationally driving the stirring member 22. In this case, it is acceptable to change the time during which the stirring member 22 is rotationally driven depending on the level of the detected temperature. That is, it is possible to recover the amount of charging of the toner by increasing the duration of rotating the stirring member 22 as the detected temperature is lower.

Moreover, it is acceptable to detect humidity in the developer cartridge 26 by a humidity sensor (not shown) in place of the temperature detecting sensor and to determine whether or not to drive the stirring member 22 on the basis of a difference in the humidity detected (detected humidity). If the humidity is high, the amount of charging of the toner in the developer cartridge 26 tends to decrease. Therefore, if the detected humidity becomes higher than preset reference humidity, the amount of charging of the toner is recovered by rotationally driving the stirring member 22. In this case, it is acceptable to change the duration of rotation (or to increase humidity when it is high) of the stirring member 22 depending on the level of the detected humidity as described above.

1. A developing device comprising:
a developer container in which a developer containing toner and carrier is received and which has a developing roller to supply the toner to an image carrier;
a developer cartridge in which a replenishing developer containing toner and carrier is received and which has a replenishing port connected to the developer container to allow the developer container to be replenished with the developer via the replenishing port; and
stirring means capable of stirring the developer located at least in the vicinity of the replenishing port in the developer cartridge.

2. The developing device as claimed in claim 1, further comprising:
stirring control means for stirring the developer by controlling driving of the stirring means before the developer container is replenished with the developer via the replenishing port.

3. The developing device as claimed in claim 2, further comprising:
timing means capable of timing a rest time of the stirring means, wherein
the stirring control means makes the stirring means drive to stir the developer when the rest time timed by the timing means elapses beyond a preset time.

4. The developing device as claimed in claim 2, further comprising:
vibration amount detecting means for detecting a vibration amount of the developer cartridge, wherein
the stirring control means makes the stirring means drive to stir the developer when a detection vibration amount detected by the vibration amount detecting means exceeds a preset reference vibration amount.

5. The developing device as claimed in claim 2, further comprising:
environment detecting means for detecting an environmental condition in the developer container, wherein
the stirring control means controls driving of the stirring means on the basis of a difference in the environmental condition detected by the environment detecting means.

6. The developing device as claimed in claim 5, wherein
the environment detecting means is either one of a humidity sensor for detecting humidity in the developer container or a temperature sensor for detecting temperature in the developer container.

7. The developing device as claimed in claim 1, wherein
the stirring means is a stirring blade which is placed on the developer container side and located at least in the vicinity of the replenishing port in the developer cartridge when the developer cartridge is mounted to the developer container.

8. The developing device as claimed in claim 1, wherein
the stirring means comprises a stirring blade placed in the developer cartridge and a rotary driving part placed on the developer container side, and
the stirring blade is connected drivably by the rotary driving part when the developer cartridge is mounted to the developer container.

9. The developing device as claimed in claim 7, wherein
the stirring blade is of a rotary type.

10. The developing device as claimed in claim 1, wherein
the developer container and the developer cartridge are placed upright and the developer container can be replenished with the developer from the developer cartridge via the replenishing port on the lower side, and
the stirring means is comprised of a conveyance screw for circulating the developer located on the lower side in the developer cartridge by upwardly conveying the developer.

11. An image forming apparatus comprising the developing device claimed in claim 1.

12. The developing device as claimed in claim 3, further comprising:
environment detecting means for detecting an environmental condition in the developer container, wherein
the stirring control means controls driving of the stirring means on the basis of a difference in the environmental condition detected by the environment detecting means.

13. The developing device as claimed in claim 4, further comprising:
environment detecting means for detecting an environmental condition in the developer container, wherein
the stirring control means controls driving of the stirring means on the basis of a difference in the environmental condition detected by the environment detecting means.

14. The developing device as claimed in claim 2, wherein
the stirring means is a stirring blade which is placed on the developer container side and located at least in the vicinity of the replenishing port in the developer cartridge when the developer cartridge is mounted to the developer container.

15. The developing device as claimed in claim 3, wherein
the stirring means is a stirring blade which is placed on the developer container side and located at least in the vicinity of the replenishing port in the developer cartridge when the developer cartridge is mounted to the developer container.

16. The developing device as claimed in claim 4, wherein
the stirring means is a stirring blade which is placed on the developer container side and located at least in the vicinity of the replenishing port in the developer cartridge when the developer cartridge is mounted to the developer container.

17. The developing device as claimed in claim 5, wherein
the stirring means is a stirring blade which is placed on the developer container side and located at least in the vicinity of the replenishing port in the developer cartridge when the developer cartridge is mounted to the developer container.

18. The developing device as claimed in claim 6, wherein
the stirring means is a stirring blade which is placed on the developer container side and located at least in the vicinity of the replenishing port in the developer cartridge when the developer cartridge is mounted to the developer container.

19. The developing device as claimed in claim 2, wherein
the stirring means comprises a stirring blade placed in the developer cartridge and a rotary driving part placed on the developer container side, and
the stirring blade is connected drivably by the rotary driving part when the developer cartridge is mounted to the developer container.

20. The developing device as claimed in claim 3, wherein
the stirring means comprises a stirring blade placed in the developer cartridge and a rotary driving part placed on the developer container side, and
the stirring blade is connected drivably by the rotary driving part when the developer cartridge is mounted to the developer container.
